(19) United States
(12) Patent Application Publication
(10) Pub. No.: US 2022/0300599 A1
(43) Pub. Date: Sep. 22, 2022

(54) Secure Login Security Services Based on a Collection of User Images

(71) Applicant: Justin Nicholas Farrelly, Richardson, TX (US)

(72) Inventor: Justin Nicholas Farrelly, Richardson, TX (US)

(21) Appl. No.: 17/695,617

(22) Filed: Mar. 15, 2022

Related U.S. Application Data
(60) Provisional application No. 63/320,044, filed on Mar. 15, 2022.
(60) Provisional application No. 63/161,817, filed on Mar. 16, 2021.

(51) Int. Cl. G06F 21/36

(52) U.S. Cl. CPC G06F 21/36; G06F 2221/2117; G06F 2221/2103

(57) ABSTRACT

An apparatus, system, and method for user authentication. The method includes receiving a request from a user to conduct a secured transaction. A user authentication session is initiated which includes a repetition of a series of image-based challenges for determining the identity of the user within a predetermined degree of certainty, the challenges including presenting a plurality of images to the user and receiving a selection from the user identifying any image from the plurality of images which is from a collection of user images. The plurality of images is different from another plurality of images presented to the user in the authentication session. The method also includes permitting the user to conduct the secured transaction in response to determining the identity of the user within the predetermined degree of certainty.

### CROSS-REFERENCE TO RELATED APPLICATION AND CLAIM OF PRIORITY

This application claims priority under 35 U.S.C. § 119(e) to U.S. Provisional Patent Application No. 63/161,817 filed on Mar. 16, 2021, and U.S. Provisional Patent Application No. 63/320,044 filed on Mar. 15, 2022. The above-identified provisional patent applications are hereby incorporated by reference in their entirety.

### TECHNICAL FIELD

Novel aspects of the present disclosure relate to the field of secure login services and more particularly to image-based authentication of a user based on a collection of personal images supplied by the user.

### BACKGROUND

Earlier forms of user authentication involved a user physically providing one or more forms of documentation to a person who could then verify the identity of the person based on a comparison of the user's face with the photograph in the provided documentation. With the proliferation of the internet and online transactions, user authentication is achieved primarily by the provision of a unique username with a corresponding password at a user interface. Once the user's identity is authenticated, the user is permitted to complete the online transaction or granted access to the secured destination.

Username and passwords are perpetually under attack. Common methods of attack include social engineering, password cracking algorithms, misappropriated equipment, copying of username and password notes, keyboard logging, shoulder surfing, and brute force attacks. To combat these attacks, the user authentication process is being made more burdensome and tedious. For example, providers of login functionality can implement unique username and password requirements specifying a certain number of numbers, letters, and special characters. Many providers also require users to periodically change their password. While these requirements make it difficult to gain unauthorized access, these requirements also make it nearly impossible for users to manage effectively. For example, a user can have an unwieldy number of username and password combinations. As a result, some users have physical or electronic lists of username and password combinations for reference. Other users may decide to implement the same username and easily remembered password combination. Still other users may rely on third party memory systems, such as a web browser password cache.

The conventional use of username and passwords for user authentication is also burdensome and risky for the various providers of the login functionality, including but not limited to applications, application program interfaces (APIs), and bureau services that offer login functionality (e.g., web browsers and web site login applications, in-house and bought-in services). These providers are required to maintain and update security and password database(s) and continually monitor for breaches. These providers can be exposed to liability for failing to protect users' login credentials.

### SUMMARY OF THE INVENTION

Novel aspects of the present disclosure are directed to a method for user authentication. The method includes receiving a request from a user to conduct a secured transaction. The request includes a unique identifier of the user. Responsive to confirming that the unique identifier is associated with a known user, e.g., a registered user, a user authentication session is initiated which includes a repetition of a series of image-based challenges for determining the identity of the user within a predetermined degree of certainty. The series of image-based challenges includes presenting a plurality of images to the user which is different from another plurality of images presented to the user in the authentication session and receiving a selection from the user identifying any image from the plurality of images which is from a collection of user images. The method also includes permitting the user to conduct the secured transaction in response to determining the identity of the user within the predetermined degree of certainty. The predetermined degree of certainty is based, at least in part, on a threshold number of correct selections received from the user.

Novel aspects of the present disclosure are also directed to a system for authenticating a user. The system includes a computing device operated by the user which is coupled to a network and a server coupled to the network. The server is configured to receive a request from a user to conduct a secured transaction. The request includes a unique identifier of the user. The server is also configured to initiate a user authentication session in response to confirming that the unique identifier is associated with a known user, e.g., a registered user. The user authentication session includes a repetition of a series of image-based challenges for determining the identity of the user within a predetermined degree of certainty. The series of image-based challenges includes presenting a plurality of images to the user which is different from another plurality of images presented to the user in the authentication session and receiving a selection from the user identifying any image from the plurality of images which is from a collection of user images. The server is also configured to permit the user to conduct the secured transaction in response to determining the identity of the user within the predetermined degree of certainty. The predetermined degree of certainty is based, at least in part, on a threshold number of correct selections received from the user.

Novel aspects of the present disclosure are also directed to an apparatus for authenticating a user. The apparatus includes a communications interface that receives data from a network, memory storing instructions for conducting an authentication session of a user, and a processor communicatively coupled with the communications interface and the memory. The processor executes the instructions to initiate the user authentication session that includes a repetition of a series of image-based challenges for determining the identity of the user within a predetermined degree of certainty. The series of image-based challenges is defined by further instructions executable by the processor to present a plurality of images that is different from another plurality of images presented to the user in the authentication session and receive a selection from the user identifying any image from the plurality of images which is from a collection of user images. The apparatus is further configured to permit the user to conduct the secured transaction in response to determining the identity of the user within the predetermined degree of certainty. The predetermined degree of certain is based, at least in part, on a threshold number of correct selections received from the user.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 is a block diagram of a system for conducting an authentication session of a user according to an illustrative embodiment;

FIG. 2 is a block diagram of a computing device operable by a user for participating in an authentication session of a user according to an illustrative embodiment;

FIG. 3 is a block diagram of a computing device for managing an authentication session of a user according to an illustrative embodiment;

FIG. 4 is a swim lane diagram depicting data flow in a system for conducting an authentication session of a user according to an illustrative embodiment;

FIG. 5 is an exemplary image-based challenge presented to a user according to an illustrative embodiment; and

FIG. 6 is a flowchart of a process for conducting an authentication session of a user according to an illustrative embodiment.

### DETAILED DESCRIPTION

Conventional solutions to the shortcomings of user authentication based on username and password attempt to use other technological solutions, such as dual factor authentication (DFA) and tokens (real and virtual). The proposed solutions have the goal of making the user authentication process more burdensome so that the process of circumvention is more difficult, but the proposed solutions are more tedious to implement.

Novel aspects of the present disclosure recognize the deficiencies attributed to the current methods of user authentication and obviates the need for written passwords, tokens, devices or dongles, or forms of dual factor authentication. Users are presented with a series of simple image-based challenges that can be quickly and easily solved based on memory recall unique to each user. The user is challenged to identify, using memory recall, personally meaningful images from a plurality of random images selected from an image pool. The image-based challenge can then be repeated with different pictures until the user's identity can be authenticated with a predetermined degree of certainty. By presenting unique image-based challenges to users in each subsequent authentication session, malicious actors are unable to obtain the correct solutions based on trial and error or brute force attacks.

Novel aspects of the present disclosure also removes the burden associated with ongoing security management of confidential login information. The user authentication solution described herein is impossible to crack on a mass username basis, and nearly impossible to compromise on a single user basis without the direct pass-method access credentials from the user being compromised.

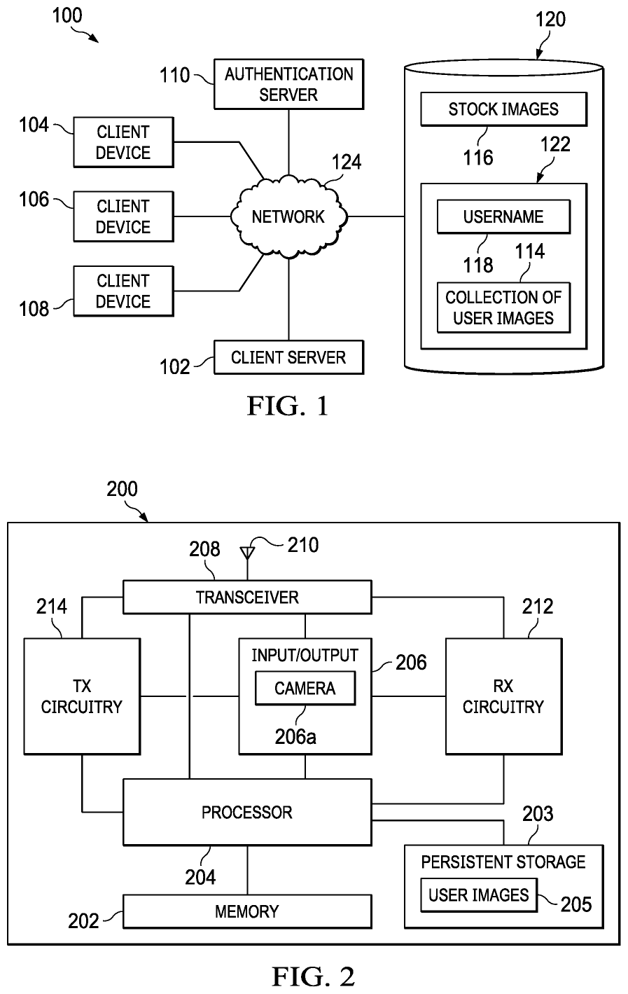

FIG. 1 is a block diagram of a system for conducting an authentication session of a user according to an illustrative embodiment. Generally, the system 100 includes a plurality of electronic devices communicating over a network to authenticate one or more users before allowing the one or more users to conduct a secured transaction. Non-limiting examples of a secured transaction can include withdrawal of money from an automated teller machine (ATM), entering a building with restricted access, checking a personal email account, or accessing a secured online destination, such as a user's social media webpage or the user's account information page on a website of a financial institution. While the novel aspects of the present disclosure can be used for user authentication prior to any conceivable transaction or interaction, for the sake of simplicity and consistency, examples in this disclosure illustrating the operation of the system 100 involve user authentication for completing a financial transaction.

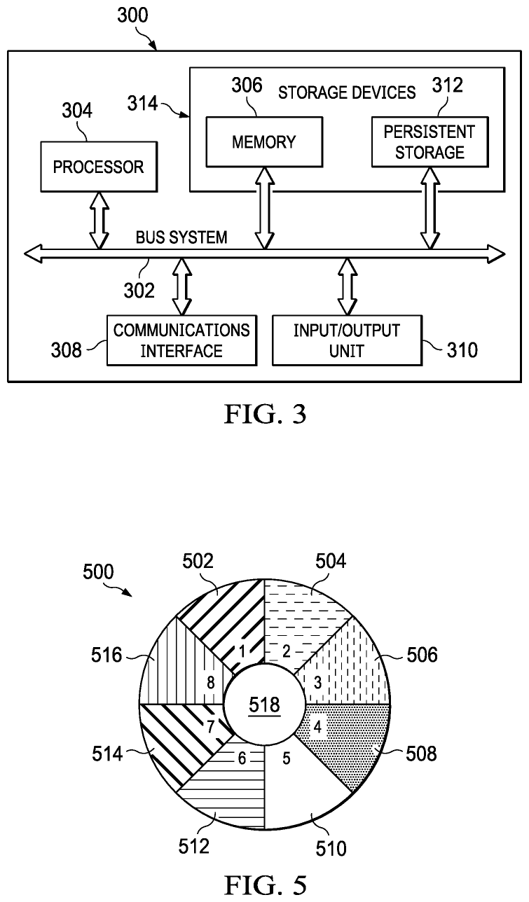

In the example where a user seeks authentication to complete a financial transaction, the user can access the user's account information page hosted on client server 102 from one or more client devices, such as client devices 104, 106, and/or 108 after the user successfully completes a series of image-based challenges presented in an authentication session managed by authentication server 110, an example of which is discussed in more detail in FIG. 3 that follows. Examples of client devices 104, 106, and 108 can include cell phones, tablets, desktop computers, or automated teller machines (ATMs). In this illustrative example in FIG. 1, client device 104 is the user's personal computing device, client device 106 is a desktop computer, and client device 108 is an ATM. An example of client device 104 is depicted in more detail in FIG. 2 that follows.

The authentication session involves presenting the user with a series of image-based challenges on client device 104 operated by the user. Each image-based challenge includes a plurality of images that may contain one or more images from a collection of user images 114 provided by the user during a registration session with any supplemental images selected from a pool of stock images 116. In some embodiments, the supplemental images can be selected from collections of user images provided by other users, or from a combination of images selected from the pool of stock images 116 and the collections of user images provided by other users.

Each of the image-based challenges requires the user to correctly select any images taken from the plurality of images from the collection of user images 114. In some embodiments, the plurality of images includes only one image from the collection of user images 114. In some other embodiments, the plurality of images includes two or more images from the collection of user images 114. In some embodiments, the plurality of images does not include any images from the collection of user images 114. Thus, the user's response to the image-based challenge can include a selection of a single image, two or more images, or no images. The selection can be made by the user interacting with an I/O interface of the client device 104.

The authentication session can be tailored to authenticate an identity of the user within a predetermined degree of certainty, which can vary based on the type of transaction conducted by the user. A degree of certainty is a likelihood that a malicious actor or other third party could correctly solve each of the image-based challenges of an authentication session by random chance. A lesser degree of certainty can be applied to authentication sessions controlling access to a social media website while a greater degree of certainty can be applied to authentication sessions controlling access to account information on a website of a financial institution.

The degree of certainty can be manipulated based on the number of images provided to the user in each image-based challenge and/or based on the number of image-based challenges to which the user is subjected. For example, a plurality of images that includes only five images with one image from the collection of user images means that a random selection of one image would have a 1-in-5 chance of being correct. Repeating the same challenge four times gives 1-in-625 chance of randomly selecting the correct images and repeating the same challenge six times gives a 1-in-15,625 chance of randomly selecting the correct images. Thus, increasing the number of challenges increases the degree of certainty established by the user authentication session.

Likewise, increasing the number of images in the plurality of images from five to eight gives a 1-in-8 chance of randomly selecting the correct image from the collection of user images. Repeating the same challenge four times gives a 1-in-4,096 chance of randomly selecting the correct images and repeating the same challenge six times gives a 1-in-262,000 chance of randomly selecting the correct images. Thus, increasing the number of images in the plurality of images also increases the degree of certainty established by the user authentication session.

The authentication session can be managed by a set of rules that can prematurely terminate the authentication session before the user's identity can be authenticated according to the desired degree of certainty. As an example, the rules can dictate the threshold number of incorrect selections that is acceptable before the authentication session is terminated. Returning to the previous examples, a threshold number of incorrect selections for an authentication session for accessing a user's social media website can be greater than a threshold number of incorrect selections for an authentication session for accessing the user's account information on a financial institution website.

The collection of user images 114 can be provided by the user in a registration session. The registration session can be completed when the user registers directly with authentication server 110. The registration session can be completed when the user attempts to acquire a new service from client server 102 which utilizes the authentication service provided by the authentication server 110. For example, if the user attempts to open a new bank account with a financial institution secured by authentication services provided by authentication server 110, the user can be redirected to authentication server 110 for completing the registration session.

During registration, the user is asked to provide a unique identifier 118, e.g., a username, as well as an initial group of images. The initial group of images can be provided by asking the user to upload a minimum number of images, or by receiving permission from the user to access the user images stored on the user's client device, e.g., user images 205 stored on client device 200 in FIG. 2. From the initial group of images, images can be discarded which may be used to identify the user. The discarded images can be any image that shows faces or other forms of identifying information, like house numbers or license plates. The collection of user images 114 culled from the initial compilation of images can be stored in storage 120 and indexed or otherwise associated with the corresponding username 118 in a data structure 122. In another embodiment, the username 118, collection of user images 114, and/or the data structure 122 can be stored in different locations, such as in local memory of a server.

Communications between the various computing devices in system 100 occur over network 124, which can include the internet, the Public Switched Telephone Network (PSTN), cellular networks, and local area networks, among others. Communication over the network 124 can be achieved using various forms of communications equipment and protocols. While client devices 104, 106, and 108 are depicted as communicating through communications links via network 124, in other embodiments the client devices 104, 106, and 108, can communicate via device-to-device communications protocols. Based on the communications sessions conducted on one or more of the client devices, the authentication server 110 can authenticate one or more users communicating via the network 124 before the one or more users can complete a secured transaction.

System 100 depicts only a single client server 102 for the sake of simplicity. However, system 100 can accommodate a plurality of client servers connected to network 124, all of which can be configured to receive authentication services from authentication server 110. In an embodiment in which a user is registered with or otherwise known to a plurality of different client servers, the username 118 and the collection of user images 114 can be used to authenticate the user's identity on each of the plurality of different client servers.

FIG. 2 is a block diagram of a computing device operable by a user for participating in an authentication session of a user according to an illustrative embodiment. The client device 200 is provided for illustration only. The client devices 104, 106, and 108 in FIG. 1 can have the same or similar configuration as the client device 200 in FIG. 2.

Client device 200 includes memory 202 storing instructions that can be executed by processor 204 for controlling the operation of the client device 200. For example, the memory can store an operating system and one or more applications that can be executed by the processor 204. The memory 202 can include random access memory (RAM), Flash memory, and/or read-only memory (ROM). Client device 200 can also include persistent storage 203 configured to store user images 205 taken by a user operating camera 206a. In a non-limiting embodiment, the collection of user images 114 can be selected from user images 205. Other sources of images from which the collection of user images 114 can be obtained can include an electronic storage device that stores the user's digital photo album(s).

I/O 206 is one or more input/output (I/O) devices of the client device 200. Examples of I/O devices include, but are not limited to, a microphone, a speaker, a camera 206a, a touch screen, a keypad. I/O 206 enables a user to interact with the client device 200 to request authorization to conduct a secured transaction, receive image-based authentication challenges, provide selections in response to the image-based authentication challenges, and/or conduct the secured transaction. In some embodiments, I/O 206 also includes I/O interfaces that provide the client device 200 with communications paths with other devices, such as other client devices and peripherals.

The transceiver 208 provides a wireless communications capability with a network, such as network 102 in FIG. 1. Incoming signals are received by the transceiver 208 from the antenna 210 and processed by the receive (RX) circuitry 212, which processes the signal and transmits the processed signal to an I/O device, such as a speaker, if the processed signal is for voice data. The processed signal can also be transmitted to the processor 204 for further processing before presentation to a user on another I/O device, such as a screen, if the processed signal is for other forms of data, such as web browsing data. Outgoing signals transmitted by the transceiver 208 from the antenna 210 are received from transmit (TX) circuitry 214. The TX circuitry 214 can receive voice data from a microphone, or other forms of outgoing data, such as web data, email, or application data, from the processor 204.

The client device 200 in FIG. 2 is depicted as a mobile phone, the client device 200 can be any other conventional client computing devices such as tablets, laptop computers, and desktop computers. For example, the transceiver depicted in the client device 200 can be replaced by a network communications interface that can support wired or wireless communication over a user's home network.

FIG. 3 is a block diagram of a computing device for managing an authentication session of a user according to an illustrative embodiment. Depending upon the particular implementation, the server 300 can be authentication server 110 in FIG. 1 or client server 102 in FIG. 1 in the event that the client server 102 provides authentication services.

Server 300 includes a bus system 302 that supports communication between at least one processor 304, at least one storage device 314, at least one communications interface 308, and at least one input/output (I/O) unit 310.

The memory 306 and a persistent storage 312 are examples of storage devices 314, which represent any structure(s) capable of storing and facilitating retrieval of information (such as data, program code, and/or other suitable information on a temporary or permanent basis). The memory 306 may represent a random access memory or any other suitable volatile or non-volatile storage device(s). The persistent storage 312 may contain one or more components or devices supporting longer-term storage of data, such as a read only memory, hard drive, Flash memory, or optical disc.

The processor 304 may execute instructions that may be loaded into the memory 306. The processor 304 may include any suitable number(s) and type(s) of processors or other devices in any suitable arrangement. Example types of processors 304 include microprocessors, microcontrollers, digital signal processors, field programmable gate arrays, application specific integrated circuits, and discreet circuitry.

The communications interface 308 may support communications with other systems or devices. For example, the communications interface 308 could include a network interface card or a wireless transceiver facilitating communications over the network 102. The communications interface 308 may support communications through any suitable physical or wireless communication link(s).

The I/O unit 310 may allow for input and output of data. For example, the I/O unit 310 may provide a connection for user input through a keyboard, mouse, keypad, touchscreen, or other suitable input device. The I/O unit 310 may also send output to a display, printer, or other suitable output device.

As described in this disclosure, the server 300 can be implemented as an authentication server or a client server in a networked computing system for managing an authentication session that authenticates an identity of a user based the user's selection of images from a plurality of images which can include images from a collection of user images.

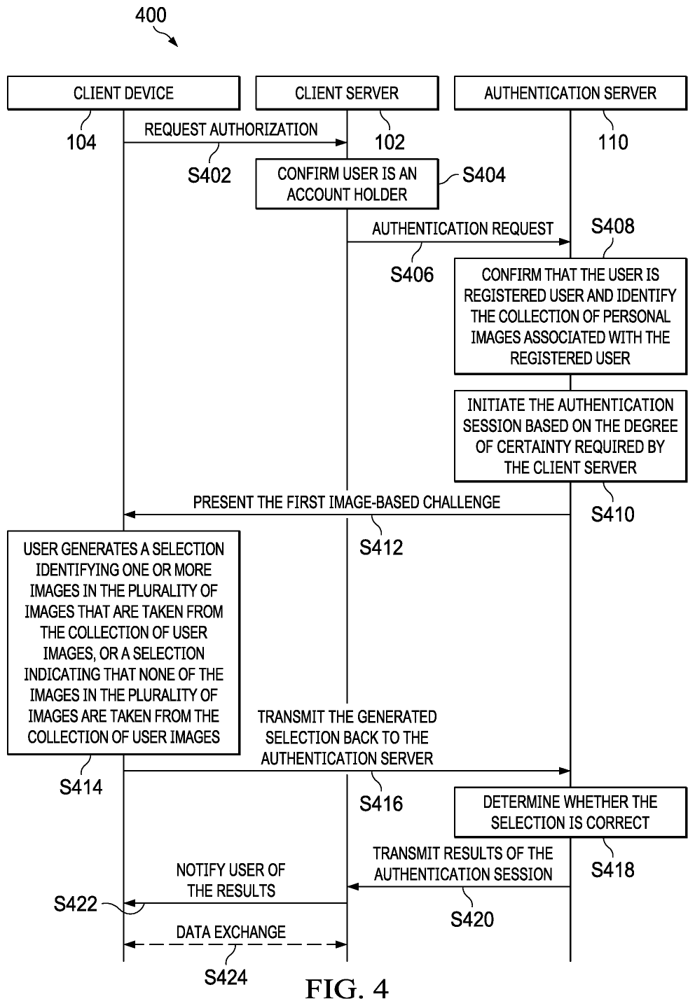

FIG. 4 is a swim lane diagram depicting data flow in a system for conducting an authentication session of a user according to an illustrative embodiment. In diagram 400, a user operating client device 104 requests authorization from client server 102 to conduct a secured transaction, and the subsequent user authentication session is managed by authentication server 110.

Generally, a secure shell (SSH) link method can be implemented for data transmission to send a query from the client server 102 to the authentication server 110. The query can include a username and an identifier of the requesting client. In response to the query, the client server 102 can receive a binary response to the authentication query, e.g., “pass” or “fail”. Verifiable certificates can be used throughout in accordance with common good practice, but which are omitted for the sake of simplicity. More detail of an exemplary data flow is provided below.

In step s402 a user operating client device 104 requests authorization to conduct a secured transaction that is managed or otherwise provided by client server 102. In this example in FIG. 4, the client server 102 hosts a website for a financial institution and the secured transaction is an account balance inquiry.

In step s404, the client server 102 confirms that the user is an account holder with the financial institution. In a non-limiting embodiment, the client server 102 can confirm that the user is an account holder by verifying that the username provided by the user corresponds with an account holder.

In step s406 the client server 102 sends an authentication request to authentication server 110. The authentication request can include the username provided by the user as well as an identifier associated with the client server 102.

In step s408, the authentication server confirms that the user is a known user, e.g., a registered user and identifies the collection of personal images associated with the registered user. The confirmation can be achieved by comparing the username with the list of registered users associated with the identifier provided by the client server 102.

In step s410, the authentication server 110 initiates the authentication session based on the degree of certainty required by the client server 102. In particular, the authentication server 110 determines the number of images in each of the plurality of images for each of the image-based challenges and the number of image-based challenges that are provided. The authentication server can also determine the threshold number of incorrect selections that will cause the authentication session to prematurely terminate, as well as the format for providing the plurality of images.

In step s412, the authentication server presents the first image-based challenge to the client device 104 for consideration by the user.

In step s414, while operating the client device 104 the user generates a selection identifying one or more images in the plurality of images that are taken from the collection of user images, or a selection indicating that none of the images in the plurality of images are taken from the collection of user images.

The selection generated in step s414 is transmitted back to the authentication server 110 in step s416, and in step s418 the authentication server determines whether the selection is correct.

Steps s412, s414, s416, and s418 can be repeated until the user can be authenticated or until the authentication session is terminated prematurely due to the receipt of a threshold number of incorrect selections.

In step s420 the result of the authentication session is transmitted to the client server 102. The result can be a simple binary message indicating “pass” or “fail”.

In step s422, the user is notified of the results of the authentication session, and in the event that the user is permitted to conduct the secured transaction, data can be exchanged between client device 104 and the client server 102 in step s424.

FIG. 5 is an exemplary image-based challenge presented to a user according to an illustrative embodiment. The image-based challenge 500 can be provided to a user on a display of a client device, such as client device 104 in FIG. 1.

In this example, the image-based challenge 500 is formed from a total of eight images, images 502, 504, 506, 508, 510, 512, 514, and 516 arranged in a wheel-shaped form. One or more of the images 502-516 can be an image selected from a collection of user images. To complete the challenge, the user can interact with an I/O interface on the client device to select the one or more images 502-516 which correspond to images from the collection of user images. The user can select the submit UI element 518 to submit the selection to authentication server 110. In the event that the user does not believe any of the images 502-516 is selected from the collection of user images, selection of the submit UI element 518 without selecting any of the images 502-516 will be considered as a response indicating that none of the plurality of images 502-516 are from the collection of user images. Upon submission of the user's response to the image-based challenge 500, the authentication server 110 determines whether the response is correct or incorrect. The challenge can be repeated a predetermined number of times until the user's identity can be authenticated according to the desired degree of certainty, or until the authentication session terminates prematurely due to a threshold number of incorrect responses from the user.

The wheel-shaped format of the image-based challenge 500 is exemplary and non-limiting. In another embodiment, the plurality of images can be presented to a user in a grid format or a scrolling ribbon format. The format in which the plurality images is presented to the user can be dictated by the client device operated by the user. For example, a user operating a mobile phone can be provided with the wheel-shaped format in FIG. 5, but a user operating an ATM can be provided with a grid format so that image selection can correspond with the number pad layout. In some embodiments, image selection can be achieved by measuring an autonomous emotional response. For example, eyeball tracking software can be used to determine which image in the plurality of image is being reviewed, and sensors provided with the client device can measure the manifestation of the emotional response by measuring certain physiological reactions, e.g., pupil dilation, increased blood pressure or heart rate, increased perspiration, etc. Images eliciting an emotional response can be deemed selected for purposes of user authentication.

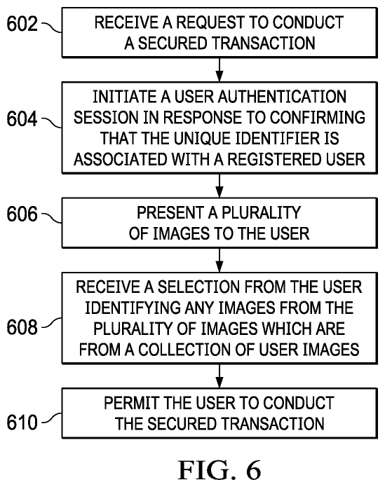

FIG. 6 is a flowchart of a process for conducting an authentication session of a user according to an illustrative embodiment. The steps of flowchart 600 can be implemented in a server, such as authentication server 110, or in client server 102 in FIG. 1 in the event that authentication session management is retained locally at the client server 102.

Flowchart 600 begins at step 602 by receiving a request from a user to conduct a secured transaction. The request can include a unique identifier of the user, such as a username.

In step 604, a user authentication session is initiated in response to confirming that the unique identifier is associated with a known user, e.g., a registered user. The authentication session can be initiated by identifying the corresponding collection of user images associated with the user, and by determining a degree of certainty necessary for the secured transaction.

The authentication session can include a repetition of a series of image-based challenges for determining the identity of the user within a predetermined degree of certainty. In a non-limiting embodiment, the series of image-based challenges includes step 606, in which a plurality of images is presented to the user. The plurality of images can be different from another plurality of images presented to the user in the authentication session. In one or more embodiments, the plurality of images can be visually similar images. The images can be presented to a user on a display of a client device, such as client devices 104, 106, and/or 108 in FIG. 1.

The series of image-based challenges also includes step 608, in which a selection is received from the user identifying any image from the plurality of images which is from a collection of user images. The selection can be inputted by the user on an I/O interface of a client device, such as client devices 104, 106, and/or 108 in FIG. 1.

In step 610, the user is permitted to conduct the secured transaction in response to determining the identity of the user within the predetermined degree of certainty. The predetermined degree of certainty is based, at least in part, on a threshold number of correct selections received from the user. In some embodiments, the predetermined degree of certainty is also based on the number of images in the plurality of images.

In some embodiments, the plurality of images presented to the user in step 606 includes at least one image from the collection of user images and at least one image from a collection of images not provided by the user. In a particular embodiment, the plurality of images includes one image from the collection of user images and a predetermined number of additional images selected from a collection of stock images or a collection of images of other users.

In some embodiments, none of the images in the plurality of images is selected from the collection of user images and the user selection indicates that the plurality of images does not include any image from the collection of user images.

In some embodiments in which the authentication session is conducted by an authentication server, such as authentication server 110 in FIG. 1, the request is received from a client server hosting the secured transaction and forwarded on to an authentication server for initiating the authentication session. In this embodiment, step 610 of permitting the user to conduct the secured transaction includes the additional steps of generating a message authenticating the user and transmitting the message to the client server to permit the user to conduct the secured transaction. The message can then be used by the client server to allow the user to conduct the authentication session.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for authenticating an identity of a user, the method comprising:
receiving a request from a user to conduct a secured transaction, wherein the request includes a unique identifier of the user;
responsive to confirming that the unique identifier is associated with a known user, initiating a user authentication session that includes a repetition of a series of image-based challenges for determining the identity of the user within a predetermined degree of certainty, wherein each of the image-based challenges includes:
presenting a plurality of images to the user, wherein the plurality of images is different from another plurality of images presented to the user in the authentication session, and
receiving a selection from the user identifying any image from the plurality of images which is from a collection of user images; and
permitting the user to conduct the secured transaction in response to determining the identity of the user within the predetermined degree of certainty, wherein the predetermined degree of certainty is based, at least in part, on a threshold number of correct selections received from the user.

2. The method of claim 1, wherein the predetermined degree of certainty is further based on the number of images in the plurality of images.

3. The method of claim 1, wherein the plurality of images are visually similar images.

4. The method of claim 1, wherein the plurality of images includes at least one image from the collection of user images, and wherein the plurality of images includes at least one image from a collection of images not provided by the user.

5. The method of claim 1, wherein none of the images in the plurality of images is selected from the collection of user images, and wherein the selection indicates that the plurality of images does not include any image from the collection of user images.

6. The method of claim 1, wherein the collection of images is provided by the user during a registration session.

7. The method of claim 1, wherein the request is received at a client server hosting the secured transaction, and wherein permitting the user to conduct the secured transaction further comprises:
generating a message authenticating the user; and
transmitting the message to the client server to permit the user to conduct the secured transaction.

8. The method of claim 1, wherein the plurality of images is presented to the user on a display of a computing device, and wherein the selection of the image from the plurality of images is received from an I/O interface of the computing device.

9. A system for conducting an authentication session of a user, the system comprising:
a computing device operated by the user, the computing device coupled to a network; and
a server coupled to the network, wherein the server is configured to:
receive a request from a user to conduct a secured transaction, wherein the request includes a unique identifier of the user;
responsive to confirming that the unique identifier is associated with a known user, initiate a user authentication session that includes a repetition of a series of image-based challenges for determining the identity of the user within a predetermined degree of certainty, the series of image-based challenges including:
presenting, for display on a display of the computing device, a plurality of images to the user, wherein the plurality of images is different from another plurality of images presented to the user in the authentication session, and
receiving, from an I/O interface of the computing device, a selection from the user identifying any image from the plurality of images which is from a collection of user images; and
permit the user to conduct the secured transaction in response to determining the identity of the user within the predetermined degree of certainty, wherein the predetermined degree of certainty is based, at least in part, on a threshold number of correct selections received from the user.

10. The system of claim 9, wherein the predetermined degree of certainty is further based on the number of images in the plurality of images.

11. The system of claim 9, wherein the plurality of images are visually similar images.

12. The system of claim 9, wherein the plurality of images includes at least one image from the collection of user images, and wherein the plurality of images includes at least one image from a collection of images not provided by the user.

13. The system of claim 9, wherein none of the images in the plurality of images is selected from the collection of user images, and wherein the selection indicates that the plurality of images does not include any image from the collection of user images.

14. The system of claim 9, wherein the collection of images is provided by the user during a registration session.

15. The system of claim 9, wherein the system further comprises:
a client server coupled to the network, the client server providing the secured transaction, wherein the user generates a request for access to the client server to conduct the secured transaction, and wherein the client server generates the request received by the server.

16. The system of claim 15, wherein the server is configured to permit the user to conduct the secured transaction by:
generating a message authenticating the user; and
transmitting the message to the client server to permit the user to conduct the secured transaction.

17. An apparatus comprising:
a communications interface that receives data from a network;
memory storing instructions for conducting an authentication session of a user; and
a processor communicatively coupled with the communications interface and the memory, and wherein the processor executes the instructions to:
initiate the user authentication session that includes a repetition of a series of image-based challenges for determining the identity of the user within a predetermined degree of certainty, the series of image-based challenges defined by further instructions executable by the processor to:
present a plurality of images to the user over the network, wherein the plurality of images is different from another plurality of images presented to the user in the authentication session, and
receive, over the network, a selection from the user identifying any image from the plurality of images which is from a collection of user images; and
permit the user to conduct the secured transaction in response to determining the identity of the user within the predetermined degree of certainty, wherein the predetermined degree of certainty is based, at least in part, on a threshold number of correct selections received from the user.

18. The apparatus of claim 17, wherein the plurality of images are visually similar images.

19. The apparatus of claim 17, wherein the plurality of images includes at least one image from the collection of user images, and wherein the plurality of images includes at least one image from a collection of images not provided by the user.

20. The apparatus of claim 19, wherein a number of the at least one image from the collection of images not provided by the user is based on the predetermined degree of certainty and a number of times the series of image-based challenges is repeated.
